(19) United States
(12) Patent Application Publication
(10) Pub. No.: US 2003/0158071 A1
(43) Pub. Date: Aug. 21, 2003

(54) Rinsing and cleaning agents

(76) Inventors: Joerg Kahre, Leichlingen (DE); Michael Elsner, Heiligenhaus (DE); Rita Koester, Duesseldorf (DE); Karl Heinz Schmid, Mettmann (DE)

Correspondence Address: COGNIS CORPORATION, 2500 RENAISSANCE BLVD., SUITE 200, GULPH MILLS, PA, 19406

(21) Appl. No.: 10/182,290

(22) PCT Filed: Jan. 19, 2001
(86) PCT No.: PCT/EP01/00611

(51) Int. Cl. C11D 17/00

(52) U.S. Cl. 510/421; 510/422; 510/470; 510/424; 510/425; 510/427

(57) ABSTRACT

A hard surface cleaning composition containing: (a) a hydroxy mixed ether corresponding to formula I:

R¹O[CH₂CHR²O]ₓ[CH₂CHR³O]_{y}CH₂CH(OH)R⁴ (I)

wherein R¹ is an alkyl and/or alkenyl group containing from about 4 to 22 carbon atoms, R² is hydrogen or a methyl or an ethyl group, R³ is hydrogen or a methyl or an ethyl group, R⁴ is an alkyl group containing from about 2 to 22 carbon atoms, x is a number up to 30, y is a number up to 30, and x+y≧1; and (b) an alkyl and/or alkenyl oligoglycoside corresponding to formula II:

R⁵O—[G]ₚ (II)

wherein R⁵ is an alkyl and/or alkenyl group containing from about 4 to 22 carbon atoms, G is a sugar unit containing 5 or 6 carbon atoms, and p is a number from 1 to 10.

### FIELD OF THE INVENTION

This invention relates to cleaning compositions containing hydroxy mixed ethers and alkyl and/or alkenyl oligoglycosides, optionally other nonionic surfactants and anionic surfactants and to the use of such mixtures in cleaning compositions.

### PRIOR ART

Compositions for the washing and cleaning of hard non-textile surfaces occurring in the home and in the institutional sector are generally intended to generate little foam in use, the foam they do generate being expected to collapse significantly in a few minutes. Compositions of this type are well-known and established on the market. They are essentially aqueous surfactant solutions of various kinds with and without added builders, solubilizers (hydrotropes) or solvents. Although the consumer prefers the in-use solution to foam to a certain extent at the beginning of the cleaning task as proof of effectiveness, the foam is expected to collapse rapidly so that cleaned surfaces do not have to be rewiped. To this end, low-foaming nonionic surfactants are normally added to compositions of the type mentioned.

DE-A 19738866 describes surfactant mixtures of hydroxy mixed ethers and nonionic surfactants, such as optionally end-capped fatty alcohol polyethylene glycol/polypropylene glycol ethers, which have very good foaming behavior and show excellent clear rinse effects in rinse agents.

It is known from German Offenlegungsschrift DT 2432757 that hydroxy mixed ethers can be used as foam suppressors in laundry detergents, dishwashing detergents and cleaning compositions.

The problem addressed by the present invention was to provide cleaning compositions which, at one and the same time, would show good foaming and cleaning behavior, more particularly a very good wetting effect on plastics, and high material compatibility of the surfaces to be cleaned.

### DESCRIPTION OF THE INVENTION

The present invention relates to cleaning compositions containing

a. hydroxy mixed ethers corresponding to formula (I):

R¹O[CH₂CHR²O]ₓ[CH₂CHR³O]_{y}CH₂CH(OH)R⁴ (I)

in which R¹ is an alkyl and/or alkenyl group containing 4 to 22 carbon atoms,

R² is hydrogen or a methyl or ethyl group,

R³ is hydrogen or a methyl or ethyl group,

R⁴ is an alkyl group containing 2 to 22 carbon atoms,

x=0 or 1 to 30,

y=0 or 1 to 30, x+y>=1,

and

b. alkyl and/or alkenyl oligoglycosides corresponding to formula (II):

R⁵O—[G]ₚ (II)

in which R⁵ is an alkyl and/or alkenyl group containing 4 to 22 carbon atoms,

G is a sugar unit containing 5 or 6 carbon atoms,

p is a number of 1 to 10.

Hydroxy Mixed Ethers

Hydroxy mixed ethers corresponding to formula (I) are known from the literature and are described, for example, in German patent application DE 19738866. They are prepared by reaction of 1,2-epoxyalkanes (R⁴CHOCH₂), where R⁴ is an aliphatic saturated, linear or branched alkyl group containing 2 to 22 and more particularly 6 to 16 carbon atoms, with alkoxylated alcohols. Hydroxy mixed ethers preferred for the purposes of the invention are those derived from alkoxylates of monohydric alcohols with the formula R¹—OH containing 4 to 18 carbon atoms, R¹ being an aliphatic, saturated, linear or branched alkyl group, more particularly containing 6 to 16 carbon atoms.

Examples of suitable straight-chain alcohols are butan-1-ol, caproic alcohol, oenanthic alcohol, caprylic alcohol, pelargonic alcohol, capric alcohol, undecan-1-ol, lauryl alcohol, tridecan-1-ol, myristyl alcohol, pentadecan-1-ol, palmityl alcohol, heptadecan-1-ol, stearyl alcohol, nonadecan-1-ol, arachidyl alcohol, heneicosan-1-ol, behenyl alcohol and the technical mixtures thereof obtained in the high-pressure hydrogenation of technical methyl esters based on fats and oils. Examples of branched alcohols are so-called oxo alcohols which generally contain 2 to 4 methyl groups as branches and are produced by the oxo process and so-called Guerbet alcohols which are branched in the 2-position by an alkyl group. Suitable Guerbet alcohols are 2-ethyl hexanol, 2-butyl octanol, 2-hexyl decanol and/or 2-octyl dodecanol.

The alcohols are used in the form of their alkoxylates which are prepared in known manner by reaction of the alcohols in any order with ethylene oxide, propylene oxide and/or butylene oxide. Alkoxylates of alcohols formed by reaction with 10 to 50 mol ethylene oxide (R² and R³=hydrogen and x+y=1-50) are preferably used. Both alkoxylates obtained by reaction of alcohol with 1 to 10 mol propylene oxide (R²=methyl, x=1-10) and 10 to 30 mol ethylene oxide (R³=hydrogen, y=10-30) and those obtained by reaction of alcohol with 10 to 30 mol ethylene oxide (R²=hydrogen, x=10-30) and 1 to 10 mol propylene oxide (R³=methyl, y=1-10) are preferred.

Particularly suitable hydroxy mixed ethers are those corresponding to formula (I), where R² is a methyl group and R³ is hydrogen, which have advantageously been produced by reaction of alcohol with 1 to 3 mol propylene oxide (x=1-3) and then with 10 to 25 mol ethylene oxide (y=10-25).

Alkyl and/or Alkenyl Oligoglycosides

The cleaning compositions according to the invention contain alkyl and/or alkenyl oligoglycosides corresponding to formula (II) as compulsory components. They may be obtained by the relevant methods of preparative organic chemistry. The synoptic articles by Biermann et al. in Starch/Stärke 45, 281 (1993) B. Salka in Cosm. Toil. 108, 89 (1993) and J. Kähre et al. in SÖFW-Journal, No. 8, 598 (1995) are cited as representative of the extensive literature available on the subject.

The alkyl and/or alkenyl oligoglycosides may be derived from aldoses or ketoses containing 5 or 6 carbon atoms, preferably glucose. Accordingly, the preferred alkyl and/or alkenyl oligoglycosides are alkyl and/or alkenyl oligoglucosides.

The alkyl group R⁵ may be derived from primary saturated alcohols. Typical examples are butan-1-ol, caproic alcohol, oenanthic alcohol, caprylic alcohol, pelargonic alcohol, capric alcohol, undecan-1-ol, lauryl alcohol, tridecan-1-ol, myristyl alcohol, pentadecan-1-ol, cetyl alcohol, palmityl alcohol, heptadecan-1-ol, stearyl alcohol, isostearyl alcohol, nonadecan-1-ol, arachidyl alcohol, heneicosan-1-ol and behenyl alcohol and the technical mixtures thereof obtained, for example, in the hydrogenation of technical fatty acid methyl esters or in the hydrogenation of aldehydes from Roelen's oxo synthesis.

The alkenyl group R⁵ may be derived from primary unsaturated alcohols. Typical examples of unsaturated alcohols are undecen-1-ol, oleyl alcohol, elaidyl alcohol, ricinolyl alcohol, linoleyl alcohol, linolenyl alcohol, gadoleyl alcohol, arachidonyl alcohol, erucyl alcohol, brassidyl alcohol, palmitoleyl alcohol, petroselinyl alcohol, arachyl alcohol and the technical mixtures thereof obtainable in the manner described above.

Alkyl or alkenyl groups R⁵ derived from primary C₆₋₁₆ alcohols are preferred. Alkyl oligoglucosides having a chain length of C₈ to C₁₀, which are obtained as first runnings in the separation of technical C₈₋₁₈ coconut fatty alcohol by distillation and which may contain less than 6% by weight of C₁₂ alcohol as an impurity, and also alkyl oligoglucosides based on technical C_{9/11} oxoalcohols are preferred. In addition, the alkyl or alkenyl group R⁵ may also be derived from primary alcohols containing 12 to 14 carbon atoms.

The index p in general formula (II) indicates the degree of oligomerization (DP), i.e. the distribution of mono- and oligoglycosides, and is a number of 1 to 10. Whereas p in a given compound must always be an integer and, above all, may assume a value of 1 to 3, the value p for a certain alkyl oligoglycoside is an analytically determined calculated quantity which is generally a broken number. Alkyl and/or alkenyl oligoglycosides having an average degree of oligomerization p of 1.1 to 2.0 are preferably used. Alkyl and/or alkenyl oligoglycosides having a degree of oligomerization of less than 2.0 and, more particularly, between 1.2 and 1.7 are preferred from the applicational point of view.

In a preferred embodiment, the cleaning compositions according to the invention contain 0.01 to 25% by weight, preferably 0.025 to 15% by weight and more particularly 0.5 to 10% by weight, based on composition, of hydroxy mixed ethers corresponding to formula (I) expressed as active substance (active substance is defined as pure substance present in the rinse agent).

In another embodiment, the cleaning compositions according to the invention contain 0.01 to 30% by weight, preferably 0.1 to 20% by weight and more particularly 0.2 to 15% by weight, based on rinse agent, of alkyl and/or alkenyl oligoglycosides corresponding to formula (II) expressed as active substance.

In another preferred embodiment, the hydroxy mixed ethers corresponding to formula (I) and alkyl and/or alkenyl oligoglycosides corresponding to formula (II) are used in a ratio by weight of 10:0.1 to 1:10, preferably 10:0.5 to 1:5 and more particularly 10:1 to 1:4.

Nonionic Surfactants

The cleaning compositions according to the invention may contain other nonionic surfactants. Typical examples of nonionic surfactants are alkoxylates of alkanols, end-capped alkoxylates of alkanols with no free OH groups, alkoxylated fatty acid lower alkyl esters, amine oxides, alkylphenol polyglycol ethers, fatty acid polyglycol esters, fatty acid amide polyglycol ethers, fatty amine polyglycol ethers, alkoxylated triglycerides, mixed ethers and mixed formals, fatty acid-N-alkyl glucamides, protein hydrolyzates (more particularly wheat-based vegetable products), polyol fatty acid esters, sugar esters, sorbitan esters and polysorbates. If the nonionic surfactants contain polyglycol ether chains, they may have a conventional homolog distribution although they preferably have a narrow homolog distribution.

The other nonionic surfactants are preferably selected from the group consisting of alkoxylates of alkanols, more particularly fatty alcohol polyethylene glycol/polypropylene glycol ethers (FAEO/PO) corresponding to formula (III) or fatty alcohol polypropylene glycol/polyethylene glycol ethers (FAPO/EO) corresponding to formula (IV), end-capped alkoxylates of alkanols, more particularly end-capped fatty alcohol polyethylene glycol/polypropylene glycol ethers or end-capped fatty alcohol polypropylene glycol/polyethylene glycol ethers, and fatty acid lower alkyl esters and amine oxides.

Fatty Alcohol Polyethylene Glycol/Polypropylene Glycol Ethers

A preferred embodiment is characterized by the use of optionally end-capped fatty alcohol polyethylene glycol/polypropylene glycol ethers corresponding to formula (III):

R⁶O(CH₂CH₂O)ₙ[CH₂(CH₃)CHO]ₘR⁷ (III)

in which R⁶ is an alkyl and/or alkenyl group containing 8 to 22 carbon atoms, R⁷ is H or an alkyl group containing 1 to 8 carbon atoms, n is a number of 1 to 40, preferably 1 to 30 and more particularly 1 to 15 and m is 0 or a number of 1 to 10.

Fatty Alcohol Polypropylene Glycol/Polyethylene Glycol Ethers

Optionally end-capped fatty alcohol polypropylene glycol/polyethylene glycol ethers corresponding to formula (IV):

R⁸O[CH₂(CH₃)CHO]q(CH₂CH₂O)ᵣR⁹ (IV)

in which R⁸ is an alkyl and/or alkenyl group containing 8 to 22 carbon atoms, R⁹ is H or an alkyl group containing 1 to 8 carbon atoms, q is a number of 1 to 5 and r is a number of 0 to 15, are also suitable.

In a preferred embodiment, the compositions according to the invention contain fatty alcohol polyethylene glycol/polypropylene glycol ethers corresponding to formula (III) in which R⁶ is an aliphatic saturated, linear or branched alkyl group containing 8 to 16 carbon atoms, n is a number of 1 to 10, m is 0 and R⁷ is hydrogen. These compounds (III) are products of the addition of 1 to 10 mol ethylene oxide onto monohydric alcohols. Suitable alcohols are the above-described alcohols, such as fatty alcohols, oxo alcohols and Guerbet alcohols. Other suitable alcohol ethoxylates are those which have a narrow homolog distribution.

Other suitable representatives of non-end-capped representatives are those corresponding to formula (III) in which R⁶ is an aliphatic, saturated, linear or branched alkyl group containing 8 to 16 carbon atoms, n is a number of 2 to 7, m is a number of 3 to 7 and R⁷ is hydrogen. These compounds (III) are products of the addition of monohydric alcohols of the type already described alkoxylated first with 2 to 7 mol ethylene oxide and then with 3 to 7 mol propylene oxide.

The end-capped compounds of formula (III) are terminated by a C₁₋₈ alkyl group (R⁷). In the literature, such compounds are also commonly referred to as mixed ethers. Suitable representatives are methyl-group-terminated compounds of formula (III) in which R⁶ is an aliphatic, saturated, linear or branched alkyl group containing 8 to 16 carbon atoms, n is a number of 2 to 7, m is a number of 3 to 7 and R⁷ is a methyl group. Compounds such as these may readily be prepared by reacting the corresponding non-end-capped fatty alcohol polyethylene glycol/polypropylene glycol ethers with methyl chloride in the presence of a base.

Suitable representatives of alkyl-group-terminated compounds are those of formula (III), in which R⁶ is an aliphatic, saturated, linear or branched alkyl group containing 8 to 16 carbon atoms, n is a number of 5 to 15, m is 0 and R⁷ is an alkyl group containing 4 to 8 carbon atoms. The end capping is preferably carried out with a linear or branched butyl group by reacting the corresponding fatty alcohol polyethylene glycol ether with n-butyl chloride or with tert.butyl chloride in the presence of bases.

Optionally end-capped fatty alcohol polypropylene glycol/polyethylene glycol ethers of formula (IV) may be present instead of or in admixture with the compounds of formula (III). Compounds such as these are described, for example, in DE-A1-43 23 252. Particularly preferred representatives of the compounds of formula (IV) are those in which R⁸ is an aliphatic, saturated, linear or branched alkyl group containing 8 to 16 carbon atoms, q is a number of 1 to 5, r is a number of 1 to 6 and R⁹ is hydrogen. Compounds such as these are preferably products of the addition of 1 to 5 mol propylene oxide and 1 to 6 mol ethylene oxide onto monohydric alcohols which have already been described as suitable in connection with the hydroxy mixed ethers.

Alkoxylated Fatty Acid Lower Alkyl Esters

Suitable alkoxylated fatty acid lower alkyl esters are surfactants corresponding to formula (V):

R¹⁰CO—(OCH₂CHR¹¹)_{w}OR¹² (V)

in which R¹⁰CO is a linear or branched, saturated and/or unsaturated acyl group containing 6 to 22 carbon atoms, R¹¹ is hydrogen or methyl, R¹² represents linear or branched alkyl groups containing 1 to 4 carbon atoms and w is a number of 1 to 20. Typical examples are the formal insertion products of on average 1 to 20 and preferably 5 to 10 mol ethylene and/or propylene oxide into the methyl, ethyl, propyl, isopropyl, butyl and tert.butyl esters of caproic acid, caprylic acid, 2-ethylhexanoic acid, capric acid, lauric acid, isotridecanoic acid, myristic acid, palmitic acid, palmitoleic acid, stearic acid, isostearic acid, oleic acid, elaidic acid, petroselic acid, linoleic acid, linolenic acid, elaeostearic acid, arachic acid, gadoleic acid, behenic acid and erucic acid and technical mixtures thereof. Normally, the products are obtained by insertion of the alkoxides into the carbonyl ester bond in the presence of special catalysts such as, for example, calcined hydrotalcite. Reaction products of on average 5 to 10 mol ethylene oxide into the ester bond of technical coconut fatty acid methyl esters are particularly preferred.

Amine Oxides

Compounds corresponding to formula (VI) and/or (VII):

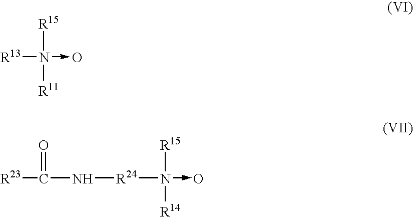

may be used as amine oxides. The amine oxides corresponding to formula (VI) are produced by oxidation of tertiary fatty amines having an least one long alkyl chain in the presence of hydrogen peroxide. In the amine oxides of formula (VI) suitable for the purposes of the invention, R¹³ is a linear or branched alkyl chain containing 6 to 22 and preferably 12 to 18 carbon atoms and R¹⁴ and R¹⁵ independently of one another have the same meaning as R¹³ or represent an optionally hydroxysubstituted alkyl group containing 1 to 4 carbon atoms. Preferred amine oxides of formula (VI) are those in which R¹³ and R¹⁴ represent C_{12/18} or C_{12/18} coconut alkyl groups and R¹⁵ is a methyl or hydroxyethyl group. Other preferred amine oxides of formula (VI) are those in which R¹³ is a C_{12/14} or C_{12/18} coconut alkyl group and R¹⁴ and R¹⁵ represent a methyl or hydroxyethyl group. Other suitable amine oxides are alkylamidoamine oxides corresponding to formula (VII) where the alkylamido group R²³CONH is formed by the reaction of linear or branched carboxylic acids preferably containing 6 to 22 and more particularly 12 to 18 carbon atoms, more particularly from C_{12/14} or C_{12/18} fatty acids, with amines. R²⁴ is a linear or branched alkenyl group containing 2 to 6 and preferably 2 to 4 carbon atoms and R¹⁴ and R¹⁵ are as defined for formula (VI).

The other nonionic surfactants may be present in the cleaning compositions according to the invention in quantities—expressed as active substance—of 0.1 to 15% by weight, preferably 0.5 to 10% by weight and more particularly 1 to 8% by weight, based on cleaning composition.

According to the invention, the cleaning compositions may contain anionic surfactants.

Anionic Surfactants

Typical examples of anionic surfactants are soaps, alkyl benzenesulfonates, secondary alkane sulfonates, olefin sulfonates, alkyl ether sulfonates, glycerol ether sulfonates, α-methyl ester sulfonates, sulfofatty acids, alkyl and/or alkenyl sulfates, alkyl ether sulfates, glycerol ether sulfates, hydroxy mixed ether sulfates, monoglyceride (ether) sulfates, fatty acid amide (ether) sulfates, mono- and dialkyl sulfosuccinates, mono- and dialkyl sulfosuccinamates, sulfotriglycerides, amide soaps, ether carboxylic acids and salts thereof, fatty acid isethionates, fatty acid sarcosinates, fatty acid taurides, N-acylamino acids such as, for example, acyl lactylates, acyl tartrates, acyl glutamates and acyl aspartates, alkyl oligoglucoside sulfates, protein fatty acid condensates (particularly wheat-based vegetable products) and alkyl (ether) phosphates. If the anionic surfactants contain polyglycol ether chains, the polyglycol ether chains may have a conventional homolog distribution, although they preferably have a narrow homolog distribution.

Alkyl and/or alkenyl sulfates, alkyl ether sulfates, alkyl benzenesulfonates, monoglyceride (ether) sulfates and alkanesulfonates, more particularly fatty alcohol sulfates, fatty alcohol ether sulfates, secondary alkanesulfonates and linear alkyl benzenesulfonates, are preferably used as anionic surfactants.

Alkyl and/or Alkenyl Sulfates

Alkyl and/or alkenyl sulfates, which are often also referred to as fatty alcohol sulfates, are understood to be the sulfation products of primary alcohols which correspond to formula (VIII):

R¹⁶O—SO₃X (VII)

in which R¹⁶ is a linear or branched, aliphatic alkyl and/or alkenyl group containing 6 to 22 carbon atoms and preferably 12 to 18 carbon atoms and X is an alkali metal and/or alkaline earth metal, ammonium, alkyl ammonium, alkanolammonium or glucammonium.

Typical examples of alkyl sulfates which may be used in accordance with the invention are the sulfation products of caproic alcohol, caprylic alcohol, capric alcohol, 2-ethyl hexyl alcohol, lauryl alcohol, myristyl alcohol, cetyl alcohol, palmitoleyl alcohol, stearyl alcohol, isostearyl alcohol, oleyl alcohol, elaidyl alcohol, petroselinyl alcohol, arachyl alcohol, gadoleyl alcohol, behenyl alcohol and erucyl alcohol and the technical mixtures thereof obtained by high-pressure hydrogenation of technical methyl ester fractions or aldehydes from Roelen's oxo synthesis. The sulfation products may advantageously be used in the form of their alkali metal salts and particularly their sodium salts. Alkyl sulfates based on C_{16/18} tallow fatty alcohols or vegetable fatty alcohols of comparable C chain distribution in the form of their sodium salts are particularly preferred.

Alkyl Ether Sulfates

Alkyl ether sulfates (“ether sulfates”) are known anionic surfactants which, on an industrial scale, are produced by SO₃ or chlorosulfonic acid (CSA) sulfation of fatty alcohol or oxoalcohol polyglycol ethers and subsequent neutralization. Ether sulfates suitable for use in accordance with the invention correspond to formula (IX):

R¹⁷O—(CH₂CH₂O)ₐSO₃X (IX)

in which R¹⁷ is a linear or branched alkyl and/or alkenyl radical containing 6 to 22 carbon atoms, a is a number of 1 to 10 and X is an alkali metal and/or alkaline earth metal, ammonium, alkylammonium, alkanolammonium or glucammonium. Typical examples are the sulfates of addition products of on average 1 to 10 and more particularly 2 to 5 moles of ethylene oxide onto caproic alcohol, caprylic alcohol, 2-ethylhexyl alcohol, capric alcohol, lauryl alcohol, isotridecyl alcohol, myristyl alcohol, cetyl alcohol, palmitoleyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol and brassidyl alcohol and technical mixtures thereof in the form of their sodium and/or magnesium salts. The ether sulfates may have both a conventional homolog distribution and a narrow homolog distribution. It is particularly preferred to use ether sulfates based on adducts of on average 2 to 3 mol ethylene oxide with technical C_{12/14} or C_{12/18} coconut fatty alcohol fractions in the form of their sodium and/or magnesium salts.

Alkyl Benzenesulfonates

Alkyl benzenesulfonates preferably correspond to formula (X):

R¹⁸—Ph—SO₃X (X)

in which R¹⁸ is a branched, but preferably linear alkyl group containing 10 to 18 carbon atoms, Ph is a phenyl group and X is an alkali metal and/or alkaline earth metal, ammonium, alkyl ammonium, alkanolammonium or glucammonium. Dodecyl benzenesulfonates, tetradecyl benzene-sulfonates, hexadecyl benzenesulfonates and technical mixtures thereof in the form of the sodium salts are preferably used.

Monoglyceride (Ether)Sulfates

Monoglyceride sulfates and monoglyceride ether sulfates are known anionic surfactants which may be obtained by the relevant methods of preparative organic chemistry. They are normally produced from triglycerides by transesterification to the monoglycerides, optionally after ethoxylation, followed by sulfation and neutralization. The partial glycerides may also be reacted with suitable sulfating agents, preferably gaseous sulfur trioxide or chlorosulfonic acid [cf. EP-B1 0 561 825, EP-B1 0 561 999 (Henkel)]. If desired, the neutralized products may be subjected to ultrafiltration to reduce the electrolyte content to a desired level [DE-A1 42 04 700 (Henkel)]. Overviews of the chemistry of monoglyceride sulfates have been published, for example, by A. K. Biswas et al. in J. Am. Oil. Chem. Soc. 37, 171 (1960) and by F. U. Ahmed in J. Am. Oil. Chem. Soc. 67, 8 (1990). The monoglyceride (ether)sulfates suitable for the purposes of the invention correspond to formula (XI):

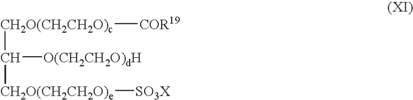

in which R¹⁹CO is a linear or branched acyl group containing 6 to 22 carbon atoms, c, d and e together stand for 0 or numbers of 1 to 30 and preferably 2 to 10 and X is an alkali metal or alkaline earth metal. Typical examples of monoglyceride (ether)sulfates suitable for the purposes of the invention are the reaction products of lauric acid monoglyceride, coconutfatty acid monoglyceride, palmitic acid monoglyceride, stearic acid monoglyceride, oleic acid monoglyceride and tallow fatty acid monoglyceride and ethylene oxide adducts thereof with sulfur trioxide or chlorosulfonic acid in the form of their sodium salts. Monoglyceride sulfates corresponding to formula (I), in which R¹⁹CO is a linear acyl group containing 8 to 18 carbon atoms, are preferably used.

Alkanesulfonates

Alkane sulfonates may be divided into primary and secondary alkanesulfonates. These are understood to be compounds corresponding to formula (XII):

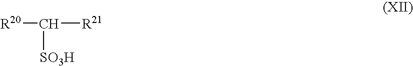

where—in the case of primary alkanesulfonates—R²⁰ is hydrogen and R²¹ is an alkyl group containing no more than 50 carbon atoms. Secondary alkanesulfonates are preferred. R²⁰ and R²¹ stand for alkyl groups and, together, should contain no more than 50 carbon atoms.

The cleaning compositions contain 0.1 to 20% by weight, preferably 0.25 to 15% by weight and more particularly 0.4 to 10% by weight, based on the composition, of anionic surfactants, expressed as active substance. The balance to 100% by weight of the compositions may be made up by auxiliaries and water.

The cleaning compositions may be formulated both as aqueous solutions and in solid form or in gel form. In a particularly preferred embodiment, they are formulated as aqueous solutions.

The pH value of the cleaning compositions in the form of aqueous solutions is preferably in the range from 4 to 6.5 and more particularly in the range from 4.5 to 6 for use as acidic cleaners. Acidic cleaners are cleaners which are adjusted to a pH of <=6.5 by addition of inorganic and organic acids, more particularly citric acid and acetic acid and salts thereof, for example trisodium citrate.

To act as alkaline cleaners, the compositions according to the invention are adjusted to a pH of 7 to 10 and preferably 7 to 8 by addition of alkali metal hydroxide, ammonia or organic bases, for example triethanolamine.

The compositions according to the invention may contain solubilizers, for example, as auxiliaries. Examples of solubilizers are cumenesulfonate, ethanol, isopropyl alcohol, ethylene glycol, propylene glycol, butyl glycol, diethylene glycol, propylene glycol monobutyl ether, polyethylene or polypropylene glycol ether with molecular weights of 600 to 1,500,000 and preferably with a molecular weight of 400,000 to 800,000 or, more particularly, butyl diglycol. Other suitable auxiliaries are foam regulators, for example soap, fatty acids, more particularly coconut fatty acid and palm kernel oil fatty acid, soluble builders, for example citric acid or sodium citrate, EDTA or NTA, abrasives, such as silica flour or wood meal or polyethylene friction elements, and thickeners, such as Acrysol®. In many cases, an additional bactericidal effect is required so that the detergents/cleaners may contain cationic surfactants or biocides, for example glucoprotamine.

The present invention also relates to the use of hydroxy mixed ethers in combination with alkyl and/or alkenyl oligoglycosides for washing and cleaning hard surfaces, preferably in the home and in the industrial and institutional sectors. These formulations are particularly suitable for bothroom cleaners, floor cleaners, so-called clean shower cleaners (for example bathroom cleaners which are sprayed onto walls and fittings before and after showering so that the water and soap residues drain off better and no wiping is necessary), cockpit cleaners (cars, aircraft, ships, motorbikes), window cleaners and all-purpose cleaners. Hard surfaces are inter alia ceramic surfaces, metal surfaces, painted surfaces, plastic surfaces and surfaces of glass, stone, concrete, china and wood.

### EXAMPLES

Performance tests. The cleaning performance of the cleaners on hard surfaces is evaluated by wiping a white soil carrier treated with test soil with a sponge soaked with the test cleaner under defined conditions. The test cleaner may be used in dilute or undiluted form. The cleaning effect is measured photoelectrically against the untreated white soil carrier (=100%) (Qualitätsnormen für Fuβbodenpflege- und Reinigungsmittel, Wischpflegemittel in Seifen-Öle-Fette-Wachse-112, 10 (1986)).

The Comparison Examples (C) are set against the Examples according to the invention (E) in the following Table.

| | C1 | E1 | E1-1 | C2 | E2 | E2-1 | C3 | E3 | E3-1 | C4 | E4 | E4-1 | E5 | E6 |
|---|---|---|---|---|---|---|---|---|---|---|---|---|---|---|
| Alkyl | 1.50 | 1.50 | 1.50 | 1.50 | 1.50 | 1.50 | 1.50 | 1.50 | 1.50 | 1.50 | 1.50 | 1.50 | 1.50 | 1.50 |
| benzene- | | | | | | | | | | | | | | |
| sulfonate | | | | | | | | | | | | | | |
| C_{12/18} FA + | 6.00 | 4.00 | 4.00 | — | — | — | — | — | — | — | — | — | — | — |
| 7EO | | | | | | | | | | | | | | |
| C_{10/14 F}A + | — | — | — | 6.00 | 4.00 | 4.00 | — | — | — | — | — | — | — | — |
| 1.20PO + | | | | | | | | | | | | | | |
| 6.4EO | | | | | | | | | | | | | | |
| C_{13/15} FA + | — | — | — | — | — | — | 6.00 | 4.00 | 4.00 | — | — | — | — | — |
| 7EO | | | | | | | | | | | | | | |
| C_{12/14} FA + | — | — | — | — | — | — | — | — | — | 6.00 | 4.00 | 4.00 | — | — |
| 5EO + 4PO | | | | | | | | | | | | | | |
| C_{8/10} FA + | — | 2.00 | — | — | 2.00 | — | — | 2.00 | — | — | 2.00 | — | 6.00 | — |
| 1PO + | | | | | | | | | | | | | | |
| 22EO C₁₀ | | | | | | | | | | | | | | |
| α-epoxide | | | | | | | | | | | | | | |
| C_{13/15} FA + | — | — | 2.00 | — | — | 2.00 | — | — | 2.00 | — | — | 2.00 | — | 6.00 |
| 7E0 C₁₂ α- | | | | | | | | | | | | | | |
| epoxide | | | | | | | | | | | | | | |
| C_{8/10}APG | 6.50 | 6.50 | 6.50 | 6.50 | 6.50 | 6.50 | 6.50 | 6.50 | 6.50 | 6.50 | 6.50 | 6.50 | 6.50 | 6.50 |
| Coconut | 0.50 | 0.50 | 0.50 | 0.50 | 0.50 | 0.50 | 0.50 | 0.50 | 0.50 | 0.50 | 0.50 | 0.50 | 0.50 | 0.50 |
| oil, palm | | | | | | | | | | | | | | |
| kernel oil | | | | | | | | | | | | | | |
| fatty acid | | | | | | | | | | | | | | |
| NaOH | 0.10 | 0.10 | 0.10 | 0.10 | 0.10 | 0.10 | 0.10 | 0.10 | 0.10 | 0.10 | 0.10 | 0.10 | 0.10 | 0.10 |
| Na | 2.00 | 2.00 | 2.00 | 2.00 | 2.00 | 2.00 | 2.00 | 2.00 | 2.00 | 2.00 | 2.00 | 2.00 | 2.00 | 2.00 |
| cumene- | | | | | | | | | | | | | | |
| sulfonate | | | | | | | | | | | | | | |
| Na | 1.00 | 1.00 | 1.00 | 1.00 | 1.00 | 1.00 | 1.00 | 1.00 | 1.00 | 1.00 | 1.00 | 1.00 | 1.00 | 1.00 |
| bicar- | | | | | | | | | | | | | | |
| bonate | | | | | | | | | | | | | | |
| Deionized | R | R | R | R | R | R | R | R | R | R | R | R | R | R |
| water | | | | | | | | | | | | | | |
| pH value | 9-10 | 9-10 | 9-10 | 9-10 | 9-10 | 9-10 | 9-10 | 9-10 | 9-10 | 9-10 | 9-10 | 9-10 | 9-10 | 9-10 |
| % total AS | 14.60 | 14.60 | 14.60 | 14.60 | 14.60 | 14.60 | 14.60 | 14.60 | 14.60 | 14.60 | 14.60 | 14.60 | 14.60 | 14.60 |
| Appearance | Clear | Clear | Clear | Clear | Clear | Clear | Clear | Clear | Clear | Clear | Clear | Clear | Clear | Clear |
| CP | 54 | 64 | 62 | 59 | 65 | 64 | 58 | 66 | 64 | 60 | 67 | 65 | 72 | 70 |
| (Gardner | | | | | | | | | | | | | | |
| Test), dilute | | | | | | | | | | | | | | |
| application | | | | | | | | | | | | | | |
| [% | | | | | | | | | | | | | | |
| reflection] | | | | | | | | | | | | | | |

1. Cleaning compositions containing
a. hydroxy mixed ethers corresponding to formula (I):
R¹O[CH₂CHR²O]ₓ[CH₂CHR³O]_{y}CH₂CH(OH)R⁴ (I)
in which R¹ is an alkyl and/or alkenyl group containing 4 to 22 carbon atoms,
R² is hydrogen or a methyl or ethyl group,
R³ is hydrogen or a methyl or ethyl group,
R⁴ is an alkyl group containing 2 to 22 carbon atoms,
x=0 or 1 to 30,
y=0 or 1 to 30, x+y>=1,
and
b. alkyl and/or alkenyl oligoglycosides corresponding to formula (II):
R⁵O—[G]ₚ (II)
in which R⁵ is an alkyl and/or alkenyl group containing 4 to 22 carbon atoms,
G is a sugar unit containing 5 or 6 carbon atoms,
p is a number of 1 to 10.

2. Compositions as claimed in claim 1, characterized in that they contain hydroxy mixed ethers corresponding to formula (I), in which R¹ is an alkyl group containing 4 to 18 carbon atoms.

3. Compositions as claimed in claim 1 or 2, characterized in that they contain hydroxy mixed ethers corresponding to formula (I), in which R² is a methyl group and R³ is hydrogen.

4. Compositions as claimed in any of claims 1 to 3, characterized in that they contain hydroxy mixed ethers corresponding to formula (I) in which x is a number of 1 to 3 and y is a number of 10 to 25.

5. Compositions as claimed in any of claims 1 to 4, characterized in that they contain alkyl and/or alkenyl oligoglycosides corresponding to formula (II), in which R⁵ is an alkyl group containing 6 to 16 carbon atoms.

6. Compositions as claimed in any of claims 1 to 5, characterized in that they contain alkyl and/or alkenyl oligoglycosides corresponding to formula (II), in which p is a number of 1 to 3.

7. Compositions as claimed in claim 1, characterized in that they contain 0.01 to 25% by weight, based on the composition, of hydroxy mixed ethers corresponding to formula (I), expressed as active substance.

8. Compostions as claimed in claim 1, characterized in that they contain 0.01 to 30% by weight, based on the composition, of alkyl and/or alkenyl oligoglycosides corresponding to formula (II), expressed as active substance.

9. Compositions as claimed in any of claims 1 to 8, characterized in that they contain other nonionic surfactants preferably selected from the group consisting of alkoxylates of alkanols, end-capped alkoxylates of alkanols with no free OH groups, alkoxylated fatty acid lower alkyl esters and amine oxides.

10. Compositions as claimed in claim 9, characterized in that they contain 0.1 to 15% by weight, based on the composition, of other nonionic surfactants, expressed as active substance.

11. Compositions as claimed in any of claims 1 to 10, characterized in that they contain anionic surfactants preferably selected from the group consisting of alkyl and/or alkenyl sulfates, alkyl ether sulfates, alkyl benzenesulfonates, monoglyceride (ether) sulfates and alkanesulfonates.

12. Compositions as claimed in claim 11, characterized in that they contain 0.1 to 20% by weight, based on the composition, of anionic surfactants, expressed as active substance.

13. Compositions as claimed in claim 1, characterized in that they are formulated as aqueous solutions.

14. Compositions as claimed in claim 13, characterized in that the pH is between 4 and 6.5.

15. Compositions as claimed in claim 13, characterized in that the pH is between 7 and 10.

16. The use of hydroxy mixed ethers in combination with alkyl and/or alkenyl oligoglycosides for washing and cleaning hard surfaces.
